(19) United States
(12) Patent Application Publication
(10) Pub. No.: US 2003/0058841 A1
(43) Pub. Date: Mar. 27, 2003

(54) Anti-offline device adapted to be used in home PNA compliant network system and the data packet transmission method thereof

(75) Inventor: Yen-Shan Lin, Taipei (JP)

Correspondence Address: VOLPE AND KOENIG, P.C., SUITE 400, ONE PENN CENTER, 1617 JOHN F. KENNEDY BOULEVARD, PHILADELPHIA, PA, 19103, US

(73) Assignee: VIA Technologies, Inc., Taipei (TW)

(21) Appl. No.: 10/160,454

(22) Filed: May 31, 2002

(30) Foreign Application Priority Data
Sep. 27, 2001 (TW) 090123986

(51) Int. Cl. H04L 12/66

(52) U.S. Cl. 370/352; 370/493; 370/445; 370/400

(57) ABSTRACT

A Home PMA compliant network system comprises a telephone wiring and at least one station. Each station includes a PHY device configured for transmitting a first data packet onto the telephone wiring and receiving a second data packet through the telephone wiring, a MAC device configured for receiving digital signals from the PHY device and detecting an error within the first data packet, and an anti-offline device disposed between the PHY device and MAC device and configured for receiving a first carrier sense signal indicating whether the telephone wiring is idle from the PHY device, and detecting whether the PHY device receives the second data packet within a prescribed time interval; If the PHY device does not receive the second data packet within the prescribed time interval, a second carrier sense signal of a longer active period than the first carrier sense signal is emitted to the MAC device.

### FIELD OF THE INVENTION

The present invention is related to an Ethernet local area network adapted to be used in a home environment, and more particularly to a HOME PNA compliant network system including an anti-offline device and the data packet transmission method thereof.

### BACKGROUND OF THE INVENTION

Local area network (LAN) utilizes a network cable or other media to link stations on a network system. Each station in the local area network architecture shares the network resource by a network interface card (NIC) having a media access control (MAC) controller.

The major standard for local area network is governed by IEEE standard 802. IEEE standard 802 describes the relationships among the 802 standard family and their relationship with the ISO OSI (open systems interconnection) reference model. In general, IEEE standard 802 prescribes the relationships between the data link layer and the physical layer for local area network and associated protocols.

In IEEE standard 802 family, IEEE standard 802.3 prescribes a network system that conforms to the ISO seven-layer model for the OSI, commonly referred to as Ethernet. The Ethernet has 10 Mbits, 100 Mbits or 1000 Mbits data transmission throughput, and uses carrier sense multiple access with collision detection (CSMA/CD) protocols to prevent two or more stations from collisions by transmitting data packets simultaneously on the shared cable.

With the improvement of Ethernet technology, the Ethernet-based local area network is by far the most popular local area network topology. The Ethernet LAN is capable of offering a fast and reliable data transmission network. Conventional local area network architecture regulates the traffic and the data flow directions over the network according to half-duplex or full-duplex Ethernet protocol through the use of a prescribed network media, such as 10 BASE-T. In an Ethernet environment, link pulses on the network are transmitted by a physical layer (PHY) transceiver of a network station. This periodic link pulse on the network medium is received by another PHY receiver for determining the presence of said network station transmitting on the network medium based on the detection of the periodic link pulse.

In order to allow the Ethernet LAN to be feasible in an ordinary home environment, home phoneline networking alliance (HOME PNA) has addressed a household telephone network system architecture, which is based on the Ethernet (IEEE standard 802.3) and constructed over telephone line to provide a data transmission rate of around 1 Mbps. HOME PNA type network system eliminates the drawbacks of high complexity and the difficulty of construction experienced by the conventional Ethernet. Insofar as the existing RJ-11 phone jacks and telephone wires are provided, multiple computers or printers can be interconnected together to construct a local area network, and further form a network neighborhood to share the network resources, while telephone and network can operate simultaneously.

As illustrated in FIG. 1, there is shown a HOME PNA type network system 10 which includes network stations 11 and 12 respectively connected to a telephone line wiring 15 (commonly it is implemented by twisted pair wires) through RJ-11 phone jacks 13 and 14. A telephone 16 is also connected to the telephone line wiring 15 through a RJ-11 phone jack 17. Therefore, the network stations 11 and 12 can construct a LAN conveniently by using the telephone line wiring 15 through the existing plain old telephone service (POTS) wiring 18, and the telephone 16 can simultaneously make phone calls while network stations 11 and 12 are communicating. The network stations 11 and 12 respectively include a physical layer (PHY) transceiver 11a and 12a, a media access control layer (MAC) device 11b and 12b and an operating system (OS) 11c and 12c. The MAC devices 11b and 12b place the data packets (or protocol data unit (PDU))of the upper layer into the frame to be transmitted to the destination network and perform the function of error detection. The PHY devices 11a and 12a transceive the data packets on the telephone line wiring 15. The operating systems 11c and 12c perform higher layer functions according to the OSI reference model.

HOME PNA type network system is designed based on the half-duplex Ethernet protocol and uses the telephone line wiring as a prescribed network medium. The half-duplex transmission mode indicates that only one of all the network appliances connected to a network is allowed to transmit data through the network medium at one time, while others stay idle. Only when the network appliance that is currently transmitting data stops data transmission, i.e. the network medium is idle, other network appliances that are inclined to transmit data can obtain the access right to the network. As a result, in a HOME PNA type network system, if a network appliance, for example, a personal computer, a printer or a consumptive electronic product, is transmitting data continuously, other network appliances are incapable of accessing the network.

Since HOME PNA type network system is based on the half-duplex transmission mode to transmit data, it is to be readily understood that if a network appliance continuously occupies the network medium to transmit data, other network appliances are unable to transmit data through the network medium. A time interval limit is desired to force the network appliance that is currently transmitting data through the network medium to abdicate the access to the network if it does not receive data from other network appliances on the network within the time interval. According to the HOME PNA 1M8 PHY specification Ver. 1.1 clause 4.4, a station on the network shall transmit a link packet if it has not transmitted a normal data or link packet within the last 2.0 second time period; if there is no reception of data and/or link packets during any time period longer than 4.0 seconds, an invalid link indication will be generated. Therefore, if any station does not receive data or link packets through the network medium within 4 seconds, the PHY device will notify the MAC device that no network appliance is connected to the network medium on the network, which causes the MAC device to deem that there is no presence of other stations on the network and stop data transmission to enter into offline state. In the mean time, other network appliances is able to obtain the access to the network to proceed with data transmission. Upon receipt of the network signals from other network appliances, the offline network appliance can restore the connection with the network and resume data transmission. However, the online/offline state circulation mechanism is the major reason for the rapid reduction of the transmission efficiency of the network appliance.

### SUMMARY OF THE INVENTION

In order to overcome the drawbacks of online/offline state circulation of the network appliance resulting from the HOME PNA specification, the present invention proposes an anti-offline device disposed between the MAC device and the PHY device of each of the stations connected to the network. The anti-offline device of the present invention is used to adjust the waveform of the carrier sense signal to drive the MAC device to delay data transmission if the station does not receive data from other stations on the network within a prescribed time interval by the HOME PNA specification. In this manner, other stations are able to obtain the access to the network to transmit data packets onto the network medium. Upon receipt of data from other stations, the adjusted waveform of the carrier sense signal can be rehabilitated to continue data transmission operation normally.

According to a first aspect of the network system of the present invention, a network station may be a personal computer, a printer or a consumptive electronic product, and is a network appliance conformable to the HOME PNA specification. The network system is constructed by interconnecting at least one network station to a telephone line medium such as twisted pair wires through a phone jack. The anti-offline device is configured for receiving a first carrier sense signal indicating whether the network medium is idle from the PHY device, and detecting whether the PHY device receives data packets from other stations within a prescribed time interval. If the PHY device does not receive data packets from other stations within the prescribed time interval, the anti-offline device emits a second carrier sense signal of a longer active period than the first carrier sense signal to the MAC device.

A preferred circuit configuration of the anti-offline device is embraced in a timer for determining whether the PHY device receives data packets from other stations within the prescribed time interval and emitting a control signal if the PHY device fails to receive data packets from other stations within the prescribed time interval, and a waveform-shaping circuit for receiving the control signal and the first carrier sense signal and generating the second carrier sense signal by adjusting the waveform of the first carrier sense signal in accordance with the control signal.

The other objects, features and advantages of the present invention will become more apparent through the following descriptions with reference to the accompanying drawings, wherein:

### BRIEF DESCRIPTION OF THE DRAWINGS

FIG. 1 is a diagram showing a HOME PNA type network system;

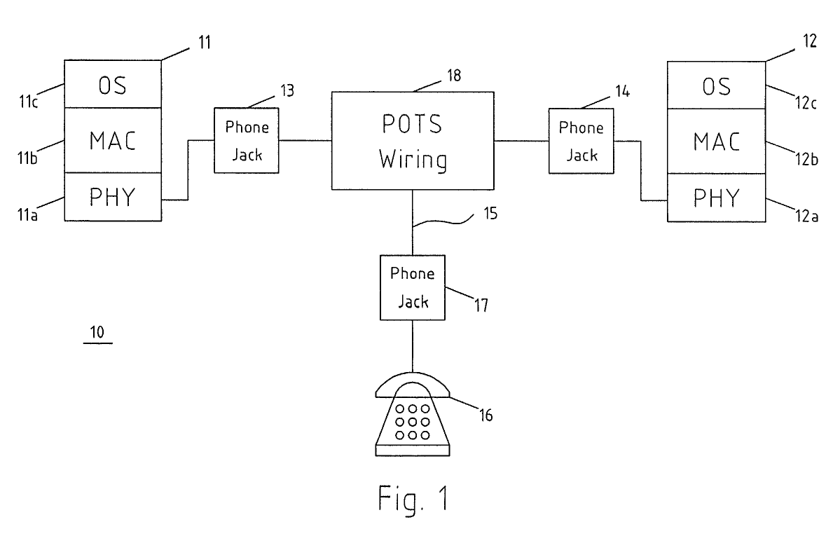

FIG. 2 is a diagram showing a media access control layer (MAC) device and a physical layer (PHY) device of a network station and the digital signals transmitted therebetween in a conventional HOME PNA type network system;

FIG. 3 is a diagram showing a MAC device and a PHY device of a network station and the digital signals transmitted therebetween in a preferred embodiment of the present invention;

FIG. 4 illustrates a functional block diagram of the anti-offline device according to a preferred embodiment of the present invention; and

FIG. 5 shows the timing diagrams of the digital signals transmitted between the MAC device and the PHY device according to a preferred embodiment of the present invention.

### DETAILED DESCRIPTION OF THE PREFERRED EMBODIMENT

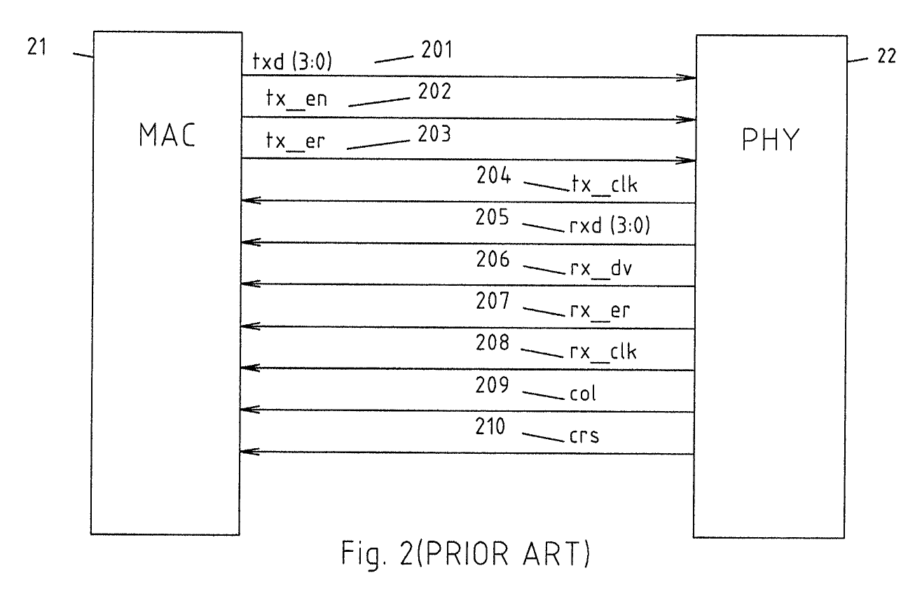

FIG. 2 shows a media access control layer (MAC) device 21 and a physical layer (PHY) device 22 included in a network station as well as the digital signals transmitted therebetween according to the prior art. The digital signals transmitted between the MAC device 21 and the PHY device 22 will be described in detail by way of the following descriptions of the preferred embodiment.

Tx_clk (transmit clock) signal 204 is a clock transmitted from the PHY device 22 to the MAC device 21 that provides the timing reference for the transmission of txd signal 201, tx_en signal 202 and tx_er signal 203. Rx_clk (receive clock) signal 208 is a continuous clock transmitted from the MAC device 21 to the PHY device 22 that provides the timing reference for the transmission of rxd signal 205, rx_dv signal 206 and rx_er signal 207. For example, Txd signal 201 is a bundle of four data signals (txd <3:0>) that transit synchronously with respect to the tx_clk signal 204. Tx_en signal 202 represents whether the MAC device 21 is transmitting nibbles to the PHY device 22. Tx_en should remain asserted when nibbles are transmitted to the PHY device 22. Tx_er (transmit error) signal 203 transits synchronously with the tx_clk signal 204, and is used to indicate that somewhere in the frames being transmitted from the MAC device 21 to the PHY device 22 contains errors.

In this embodiment, Rxd signal 205 is a bundle of four data signals (rxd <3:0>) that transits synchronously with respect to the rx_clk signal 208. Rx_dv (receive data valid) signal 206 is driven by the PHY device 22 to indicate that the PHY device 22 is recovering and decoding the nibbles transmitted from the bundle of rxd <3:0>, and that the data transmitted on the bundle of rxd <3:0> is synchronous with rx_clk signal 208. Rx_er (receive error) signal 207 is driven by the PHY device 22 to indicate that an error was detected somewhere in the frame currently transmitted from the PHY device 22 to the MAC device 21. Col signal 209 is asserted by the PHY device 22 upon the detection of a collision on the network medium (e.g. telephone wire), and remains asserted when the collision situation sustains. Finally, crs (carrier sense) signal 210 is asserted by the PHY device 22 when either the transmit or the receive medium is not idle, and is deasserted by the PHY device 22 when its communication cable (i.e. the network medium) is not idle, and is deasserted by the PHY device 22 when the communication cable is idle.

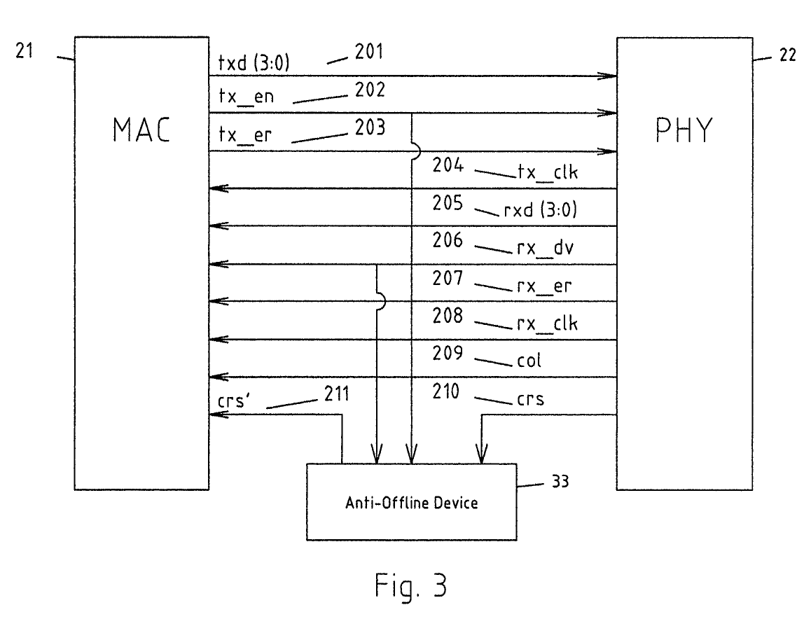

It can be readily understood from the above interpretations that the MAC device 21 and the PHY device 22 employ tx_clk signal 204 and rx_clk signal 208 to synchronously transmit or receive data, and employ col signal 209 and crs signal 210 to respectively detect whether a collision is present on the network medium and whether the network medium is idle. Further, as mentioned above, according to HOME PNA 1M8 PHY specification Ver. 1.1 clause 4.4, a station on the network shall transmit a link packet if it has not transmitted a normal data or link packet within the last 2.0 second time period; if no reception of data and/or link packets within a time period of not less than 4.0 seconds, an invalid link indication will be generated. As shown in FIG. 3, for the purpose of obviating the drawback in the low transmission efficiency of the prior art, an anti-offline device 33 is provided and deposited between the MAC device 21 and the PHY device 22 according to a preferred embodiment of the present invention, and can be used to continuously detect tx_en signal 202, rx_dv signal 206 and crs signal 210. The anti-offline device 33 is capable of detecting whether the PHY device 22 receives data from other stations within a prescribed time interval by the HOME PNA specification, and emitting an adjusted carrier sense signal crs′ 211 generated by extending the active period of the crs signal 210 for a while if the PHY device 22 does not receive data from other stations within the time interval as prescribed by the HOME PNA specification. The MAC device 21 thereby deems that there is data currently transmitting on the network medium and delays the data transmission for a while. Other stations may transmit data onto the network medium when the network medium is idle. When the PHY device 22 receives data from other stations connected to the network medium, the anti-offline device 33 will directly pass the original received crs signal 210 to the MAC device 21 and stop adjusting the waveform of the crs signal 210.

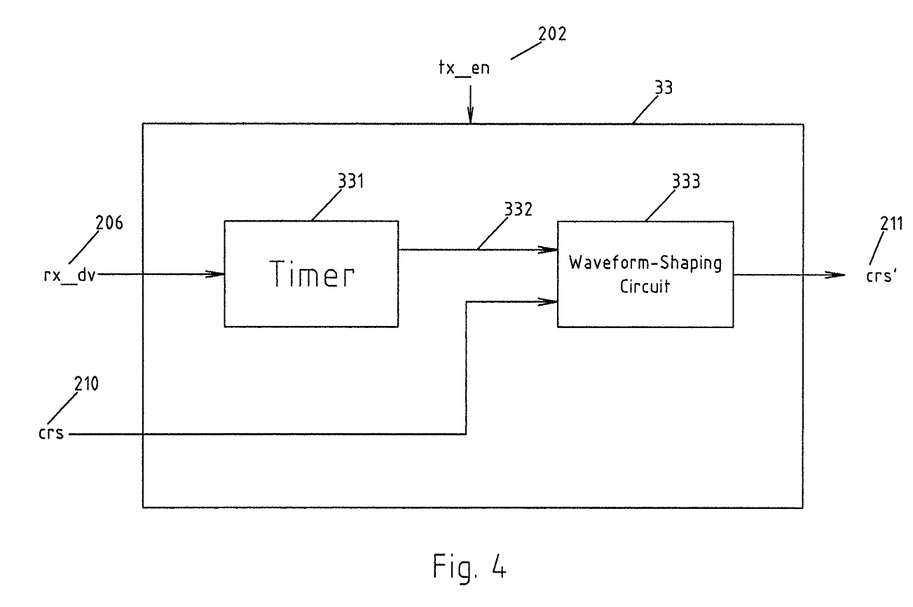

FIG. 4 exhibits a functional block diagram of the anti-offline device 33 according to a preferred embodiment of the present invention. In FIG. 4, a preferred circuit configuration of the anti-offline device 33 includes a timer 331 which receives the rx_dv signal 206 to determine whether the PHY device 22 receives data or link packets from other stations on the network within the prescribed time interval by the HOME PNA specification, and emits a control signal 332 if the PHY device 22 does not receive data or link packets from other stations on the network within the prescribed time interval. The anti-offline device 33 further includes a waveform-shaping circuit 333 which receives the control signal 332 through the timer 331 and a first carrier sense signal (crs signal 210) indicating whether the network medium (telephone wire) is idle, and generates a second carrier signal (crs′ signal 211) by adjusting the waveform of the first carrier sense signal 210 according to the control signal 332, and emits the second carrier signal (crs′ signal 211) to the MAC device 21.

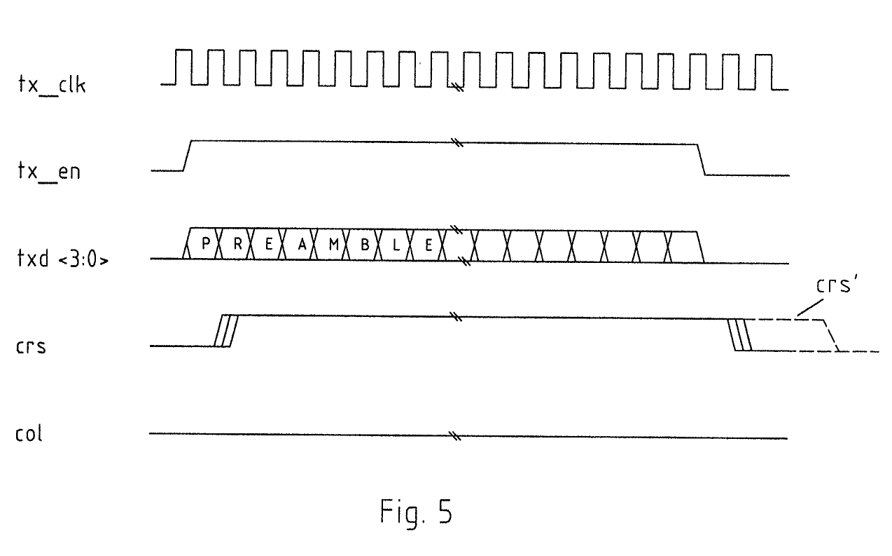

Under the presupposition that no collision occurs on the network medium, the timing diagrams of the digital signals of tx_clk signal 204, tx_en signal 202, txd signal 201, the first carrier sense signal (crs signal) 210, the second carrier sense signal (crs′ signal)211 and col signal 209 transmitted between the MAC device 21 and the PHY device 22 are shown in FIG. 5. It can be seen from FIG. 5 that the segment of the waveform as indicated by dotted lines represents a portion of the second carrier sense signal (crs′ signal) 211, which is derived by adjusting the waveform of the first carrier signal (crs signal) 210 to extend its active period for a while. If the PHY device 22 of a network station does not receive data packets from other stations on the network within the prescribed time interval by the HOME PNA specification (i.e. 2 seconds), and the MAC device 21 requests to transmit data packets onto the network medium at the moment, it will become offline because other stations can not transmit data packets onto the network medium within the prescribed time interval. Nonetheless, upon receipt of the second carrier sense signal (crs′ signal) 211 by the MAC device 21, the MAC device 21 will determine according to the state of the second carrier sense signal (crs′ signal) 211 that the network medium currently is in use by other stations, whereby delaying its data transmission onto the network medium for a while (as the extended active period indicated by the dotted lines). That allows other stations connected to the network medium to take the opportunity to obtain the access to the network and transmit data packets thereon, so as to prevent other stations from failing to transmit data packets within the prescribed time interval to cause an invalid link indication and resulting in a faulty operation of the station that is transmitting data packets continuously.

In accordance with anti-offline technology of the present invention, the anti-offline device 33 of the present invention is configured to delay for a short period after a continuous data transmission continuing for 2 to 4 seconds. Furthermore, the time for the delay of data transmission is very short, which ranges from tens to hundreds bit times. Also, when the PHY device 22 receives data packets from other stations through the network medium, the timer 331 of the anti-offline device 33 will be zeroed and stop emitting the control signal 332. The waveform-shaping circuit 333 will stop the waveform shaping of the first carrier sense signal 210, but directly pass the first carrier sense signal 210 to the MAC device 21. The anti-offline technology to be used in a HOME PNA type network system of the present invention can accurately determine whether the PHY device 22 receives data packets from other stations within a prescribed time interval, and adjusting the waveform of the carrier sense signal 210 by extending the active period of the carrier sense signal 210 if the PHY device 22 fails to receive data packets from other stations within the prescribed time interval. That could enable the MAC device 21 to deem that the network medium is in use and delay the data transmission. Other stations may transmit data onto the network medium to prevent the station that is continuously transmitting data from going offline. Preferably, the anti-offline device 33 of the present invention can be built in a PHY chip 22 or independently implemented as an external auxiliary circuit depending on the design requirements.

The HOME PNA compliant network system of the present invention is peculiarized by that the carrier sense signal is not directly transmitted from the PHY device 22 to the MAC device 21, but is bypassed through an anti-offline device 33 coupled to the MAC device 21. The anti-offline device 33 monitors the status of the signal transmission/reception between the PHY device 22 and the MAC device 21, and adjusts the waveform of the carrier sense signal by extending its active period if the PHY device 22 does not receive data packets from other stations within a prescribed time interval. By introducing the anti-offline device 33 into the HOME PNA type network system, the network station that is continuously transmitting data can share the network resource and information with other network stations without seriously affecting its data transmission operation, and further the transmission efficiency of the whole network system can be improved significantly.

Although the present invention has been described and illustrated in detail, it is to be clearly understood that the same is by the way of illustration and example only and is not to be taken by way of limitation, the spirit and scope of the present invention being limited only by the terms of the appended claims.

What is claimed is:

1. A network station configured for transmitting and receiving network signals from other network stations on a telephone line medium, said network station comprising:
a physical layer device configured for transmitting a first data packet onto said telephone line medium and receiving a second data packet through said telephone line medium; and
a media access control layer device configured for receiving digital signals from said physical layer device and detecting an error within said first data packet; and
an anti-offline device deposited between said physical layer device and said media access control layer device, which is configured for receiving a first carrier sense signal indicating whether said telephone line medium is idle from said physical layer device and detecting whether said physical layer device receives said second data packet within a prescribed time interval, and if said physical layer device fails to receive said second data packet within said prescribed time interval, emits a second carrier sense signal of a longer active period than said first carrier sense signal to said media access control layer device.

2. The network station of claim 1 wherein said network station comprises one selected from a group consisting of a personal computer, a printer and a consumptive electronic product.

3. The network station of claim 1 wherein said network station is a network appliance compliant with a home phoneline networking alliance specification.

4. The network station of claim 1 wherein said anti-offline device comprises:
a timer for determining whether said physical layer device receives said second data packet within said prescribed time interval and emitting a control signal if said physical layer device fails to receive said second data packet within said prescribed time interval; and
a waveform-shaping circuit for receiving said control signal and said first carrier sense signal and generating said second carrier sense signal by adjusting a waveform of said first carrier sense signal in response to said control signal.

5. A network system adapted to be used in a home environment, comprising:
a telephone line medium for transmitting a network signal; and
at least one network station, each of which is connected to said telephone line medium through a phone jack;
wherein each of said network station comprises:
a physical layer device configured for transmitting a first data packet onto said telephone line medium and receiving a second data packet through said telephone line medium;
a media access control layer device configured for receiving digital signals from said physical layer device and detecting an error within said first data packet; and
an anti-offline device deposited between said physical layer device and said media access control layer device, which is configured for receiving a first carrier sense signal indicating whether said telephone line medium is idle from said physical layer device and detecting whether said physical layer device receives said second data packet within a prescribed time interval, and if said physical layer device fails to receive said second data packet within said prescribed time interval, emits a second carrier sense signal of a longer active period than said first carrier sense signal to said media access control layer device.

6. The network system of claim 5 wherein said network system is compliant with a home phoneline networking alliance specification.

7. The network system of claim 5 wherein said network station comprises one selected from a group consisting of a personal computer, a printer and a consumptive electronic product.

8. The network system of claim 5 wherein said network station is a network appliance compliant with a home phoneline networking alliance specification.

9. The network system of claim 5 wherein said phone jack is a RJ-11 phone jack.

10. The network system of claim 5 wherein said telephone line medium comprises twisted pair wires.

11. The network system of claim 5 wherein said anti-offline device comprises:
a timer for determining whether said physical layer device receives said second data packet within said prescribed time interval and emitting a control signal if said physical layer device fails to receive said second data packet within said prescribed time interval; and
a waveform-shaping circuit for receiving said control signal and said first carrier sense signal and generating said second carrier sense signal by adjusting a waveform of said first carrier sense signal in accordance with said control signal.

12. A method for transmitting data packets through a telephone line medium comprising the steps of:
providing at least one first network station and one second network station connected to said telephone line medium;
enabling said first network station to transmit a first data packet to said second network station through said telephone line medium and receive a second data packet from said second network station through said telephone line medium;
detecting whether said first network station receives said second data packet through said telephone line medium within a prescribed time interval;
if said first network station fails to receive said second data packet through said telephone line medium within said prescribed time interval, adjusting a waveform of a first carrier sense signal indicating whether said telephone line medium is idle to generate a second carrier sense signal; and
delaying transmitting a third data packet onto said telephone line medium according to said second carrier sense signal in order that said second network station transmits said second data packet onto said telephone line medium.

13. The method of claim 12 further comprising the step of:
if said first network station receives said second data packet through said telephone line medium, stop adjusting said first carrier sense signal.
